(19) United States
(12) Patent Application Publication
(10) Pub. No.: US 2024/0001931 A1
(43) Pub. Date: Jan. 4, 2024

(54) STATE ESTIMATION DEVICE, STATE ESTIMATION METHOD, AND STORAGE MEDIUM

(71) Applicant: TOYOTA JIDOSHA KABUSHIKI KAISHA, Aichi-ken (JP)

(72) Inventor: Takafumi KURANO, Toyota-shi (JP)

(21) Appl. No.: 18/307,013

(22) Filed: Apr. 26, 2023

(30) Foreign Application Priority Data
Jun. 30, 2022 (JP) 2022-106691

(51) Int. Cl. B60W 40/06; B60W 40/13

(52) U.S. Cl. CPC B60W 40/06; B60W 40/13; B60W 2510/00

(57) ABSTRACT

A state estimation device includes: a behavior acquiring unit configured to acquire information on vehicle behavior of front wheels and rear wheels of a vehicle; and an estimation unit configured to estimate that road surface damage is present when a value associated with the front wheels in the information on vehicle behavior is greater than a first threshold value and a value associated with the rear wheels is greater than a second threshold value.

### CROSS-REFERENCE TO RELATED APPLICATION

This application claims priority to Japanese Patent Application No. 2022-106691 filed on Jun. 30, 2022, incorporated herein by reference in its entirety.

### BACKGROUND

### 1. Technical Field

The present disclosure relates to a state estimation device, a state estimation method, and a storage medium.

### 2. Description of Related Art

Japanese Patent Application Publication No. 2011-242293 (JP 2011-242293 A) discloses a technique for achieving an increase in efficiency of inspection of a plurality of structures and equipment associated with roads. In this technique, a pavement surface is imaged by a visible-ray camera and shapes of the pavement surface are collected by a pavement surface measuring unit.

### SUMMARY

The patent publication describes that damage is detected using image recognition of the shapes of the pavement surface. However, when an image is used, it is affected by changes in visibility from road surface conditions such as nighttime, rain, dust, fallen leaves, or puddles. Accordingly, an image may not be correctly recognized in situations in which it is difficult to visually recognize road surface damage. It is also conceivable to detect road surface damage using a variation in rotation speed, vibration, or the like associated with a vehicle, but accidental variation or vibration may be detected and thus there is a likelihood that detection accuracy will not be satisfactory.

The present disclosure provides a state estimation device, a state estimation method, and a storage medium that secure detection accuracy of road surface damage without being affected by external factors or accidental vibration.

According to a first aspect of the disclosure, there is provided a state estimation device including: a behavior acquiring unit configured to acquire information on vehicle behavior of front wheels and rear wheels of a vehicle; and an estimation unit configured to estimate that the road surface damage is present when a value associated with the front wheels in the information on vehicle behavior is greater than a first threshold value and a value associated with the rear wheels is greater than a second threshold value.

With the state estimation device according to the first aspect, it is possible to secure detection accuracy of road surface damage without being affected by external factors or accidental vibration. It is possible to detect road surface damage in a manner that is robust to external factors.

A state estimation device according to a second aspect is the state estimation device according to the first aspect, wherein the estimation unit determines whether the value is greater than the first threshold value for each of the front-right wheel and the front-left wheel in the information on vehicle behavior and determines whether the value is greater than the second threshold value for each of the rear-right wheel and the rear-left wheel in the information on vehicle behavior, and the estimation unit estimates that the road surface damage is present when the value associated with the front-left wheel is greater than the first threshold value and the value associated with the rear-left wheel is greater than the second threshold value or when the value associated with the front-right wheel is greater than the first threshold value and the value associated with the rear-right wheel is greater than the second threshold value.

With the state estimation device according to the second aspect, since the threshold values for the front-left wheel and the rear-left wheel are determined and presence of road surface damage is estimated through the determination of the threshold values for the front-left wheel and the rear-left wheel, it is possible to detect road surface damage in a manner that is robust to right and left accidental events in the vehicle.

A state estimation device according to a third aspect is the state estimation device according to the first or second aspect, wherein variation in wheel rotation speed of each tire of the vehicle is used as the information on vehicle behavior.

With the state estimation device according to the third aspect, it is possible to detect road surface damage using information which can be acquired as vehicle information.

A state estimation device according to a fourth aspect is the state estimation device according to any one of the first to third aspects, wherein the behavior acquiring unit acquires the information on vehicle behavior from a plurality of vehicles, the estimation unit determines whether the value of the front wheels of a corresponding vehicle is greater than the first threshold value and determines whether the value associated with the rear wheels of the vehicle is greater than the second threshold for each of the plurality of vehicles, and the estimation unit estimates that the road surface damage is present when the number of vehicles for which the value is greater than the first threshold value and the number of vehicles for which the value is greater than the second threshold value satisfy a predetermined condition.

With the state estimation device according to the fourth aspect, since road surface damage is estimated based on the conditions in a plurality of vehicles, it is possible to accurately detect road surface damage.

A state estimation device according to a fifth aspect is the state estimation device according to any one of the first to fourth aspects, wherein the behavior acquiring unit acquires the information on vehicle behavior from each of the plurality of vehicles for each predetermined area, and the estimation unit performs the determination using the first threshold value and the second threshold value for each predetermined area and estimates that the road surface damage is present when the predetermined condition is satisfied.

With the state estimation device according to the fifth aspect, it is possible to estimate road surface damage for each area.

A state estimation device according to a sixth aspect is the state estimation device according to any one of the first to fifth aspects, wherein the first threshold value and the second threshold value are set to different values according to information on a load of the vehicle for each type of the vehicle.

With the state estimation device according to the sixth aspect, it is possible to set the threshold values for each type of vehicle.

A state estimation device according to a seventh aspect is the state estimation device according to the sixth aspect, wherein the first threshold value is set to be smaller than the second threshold value when the vehicle is of a type with a vehicle body structure of front-wheel drive.

With the state estimation device according to the seventh aspect, it is possible to set the threshold values for each vehicle body structure.

A state estimation device according to an eighth aspect is the state estimation device according to any one of the first to seventh aspects, wherein the first threshold value and the second threshold value are set to different values using a trained model which has been trained by machine learning based on the information on a load of each vehicle, the information on vehicle behavior for training collected for each vehicle type, and a correct answer label of road surface damage for each vehicle type.

With the state estimation device according to the eighth aspect, it is possible to set the threshold values using a trained model.

According to a ninth aspect, there is provided a state estimation method that is performed by a processor of a computer, the state estimation method including: acquiring information on vehicle behavior of front wheels and rear wheels of a vehicle; and estimating that road surface damage is present when a value associated with the front wheels in the information on vehicle behavior is greater than a first threshold value and a value associated with the rear wheels is greater than a second threshold value.

According to a tenth aspect, there is provided a storage medium storing a state estimation program causing a processor of a computer to perform: acquiring information on vehicle behavior of front wheels and rear wheels of a vehicle; and estimating that road surface damage is present when a value associated with the front wheels in the information on vehicle behavior is greater than a first threshold value and a value associated with the rear wheels is greater than a second threshold value.

With the technique according to the present disclosure, it is possible to secure detection accuracy of road surface damage without being affected by external factors or accidental vibration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of an image of a vehicle traveling somewhere with road surface damage;

FIG. 2 is a graph for comparing a maximum value of variation in rotation speed and a frequency of variation in rotation speed which are acquired from vehicles traveling on a road surface with damage and a road surface with no damage;

FIG. 3 is a diagram illustrating determination of a threshold value for a front wheel and a rear wheel on the right or left side;

FIG. 4 is a diagram schematically illustrating a configuration of a state estimation system according to an embodiment;

FIG. 5 is a block diagram illustrating a hardware configuration of a vehicle according to the embodiment;

FIG. 6 is a block diagram illustrating a hardware configuration of a server according to the embodiment;

FIG. 7A is a diagram illustrating an example of a graph representing variation in rotation speed;

FIG. 7B is a diagram illustrating an example of a graph representing variation in rotation speed;

FIG. 8 is a block diagram illustrating a functional configuration of the server according to the embodiment;

FIG. 9 is a flowchart illustrating a routine of a state estimating process which is performed by the server according to the embodiment;

FIG. 10 is a graph in which maximum values of variation in rotation speed on a traveling road with road surface damage are collected and plotted; and

FIG. 11 is a graph in which maximum values of variation in rotation speed on a traveling road with no road surface damage are collected and plotted.

### DETAILED DESCRIPTION OF EMBODIMENTS

An embodiment of the present disclosure is based on the premise of a technique of detecting road surface damage using variation in rotation speed (hereinafter referred to as rotation speed variation), vibration, or the like which are associated with a vehicle. The rotation speed includes a wheel rotation speed of tires, a rotation speed of a drive shaft, a rotation speed of a crank shaft of an engine, and a rotation speed of the engine. The vibration includes vibration of components installed in a vehicle (resonance of a shock absorber, a coil spring, and a sheet-metal part and vibration of parts attached to a vehicle body) and vibration of parts due to inside and outside sound. In this embodiment, it is assumed that the vibration is rotation speed variation in wheel rotation speed of tires.

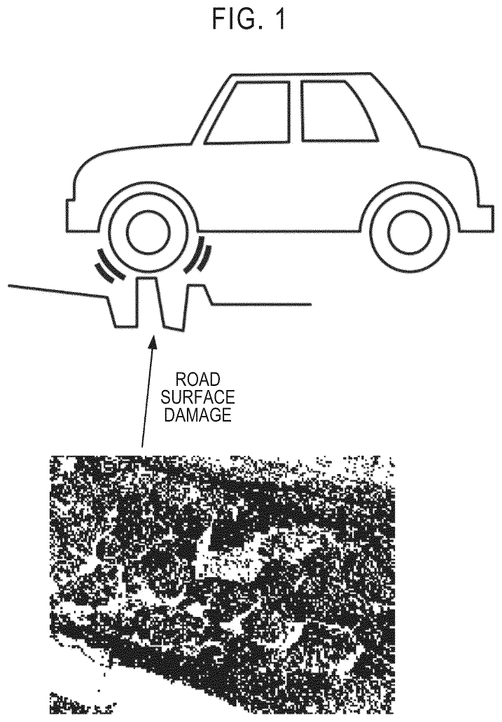

An example of an image of a vehicle traveling somewhere with road surface damage is illustrated in FIG. 1. As illustrated in FIG. 1, road surface damage is a damaged portion on a road, and variation in rotation speed associated with a vehicle occurs when the vehicle passes through a place with the road surface damage. The road surface damage illustrated in FIG. 1 is a depression of a road surface which is called a pothole. It is conceivable that variation in rotation speed of wheels of a vehicle occurs due to an accidental event other than road surface damage. The accidental event other than road surface damage is, for example, traveling on fallen leaves or stepped gutter portions due to avoidance behavior. With such an accidental event, the rotation speed associated with the vehicle may vary for one wheel among the four wheels of the vehicle.

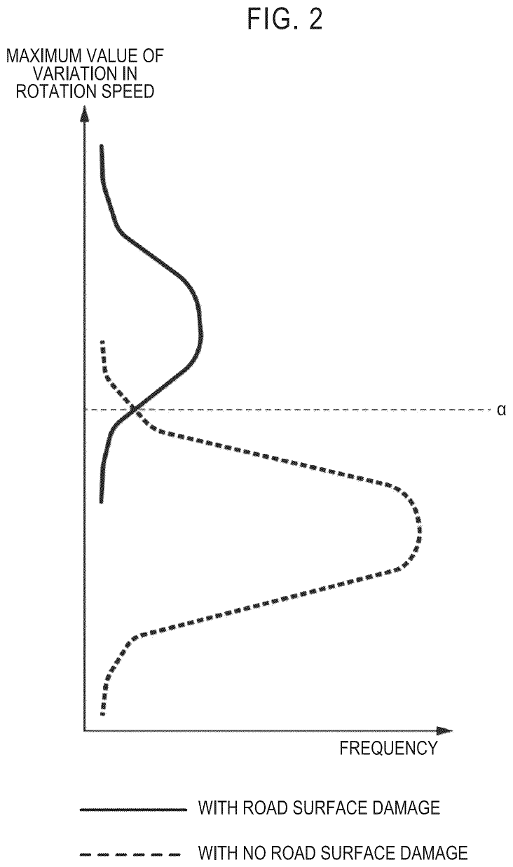

FIG. 2 is a graph for comparing a maximum value of variation in rotation speed and a frequency of variation in rotation speed which are acquired from vehicles traveling on a road surface with damage and a road surface with no damage. The vertical axis represents the maximum value of variation in rotation speed and the horizontal axis represents the frequency thereof. Basically, the maximum value of variation in rotation speed on a road surface with damage is greater than that on a road surface with no damage. The frequency at which traveling on a road surface with damage is observed is low, but it is conceivable that it can be observed with a sufficient probability if data can be acquired from a plurality of vehicles. Here, a condition (a) for setting a threshold value is that the threshold value is set to a value of variation in rotation speed at which the frequency on a road surface with damage increases. Even on a road surface with no damage, the value of variation in rotation speed may have a large value due to an accidental event. The maximum value or a variable value of variation in rotation speed or a maximum value or a variable value of vibration is an example of information on vehicle behavior in the claims.

Accordingly, in this embodiment, measures for reducing a likelihood of erroneous detection of an accidental event are introduced. In this embodiment, a threshold value is set for each of front wheels and rear wheels, and road surface damage is estimated when a value observed at the same spot exceeds the threshold value for the front wheel and the rear wheel on one of the right and left sides. This is in consideration of the fact that there is a low likelihood of occurrence of an accidental event on both the front wheel and the rear wheel at the same point. Through determination using the threshold value for the front wheel and the rear wheel on one of the right and left sides, it is possible to cope with a case in which road surface damage is present on one side of the vehicle. An important point of view in the technique according to this embodiment is that variation in rotation speed or vibration has a peak equal to or greater than a predetermined magnitude.

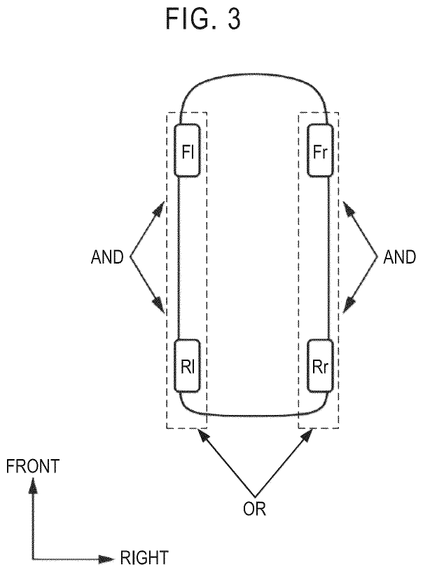

FIG. 3 is a diagram illustrating determination of the threshold value for the front wheel and the rear wheel on one of the right and left sides. Determination using the threshold value for left wheels is performed when the threshold value for the front-left wheel (Fl) and the rear-left wheel (Rl) is exceeded. Determination using the threshold value for right wheels is performed when the threshold value for the front-right wheel (Fr) and the rear-right wheel (Rr) is exceeded. In this embodiment, a road surface is estimated to have damage when the condition of one of determination using the threshold value for the left wheels and determination using the threshold value for the right wheels is satisfied.

Entire Configuration

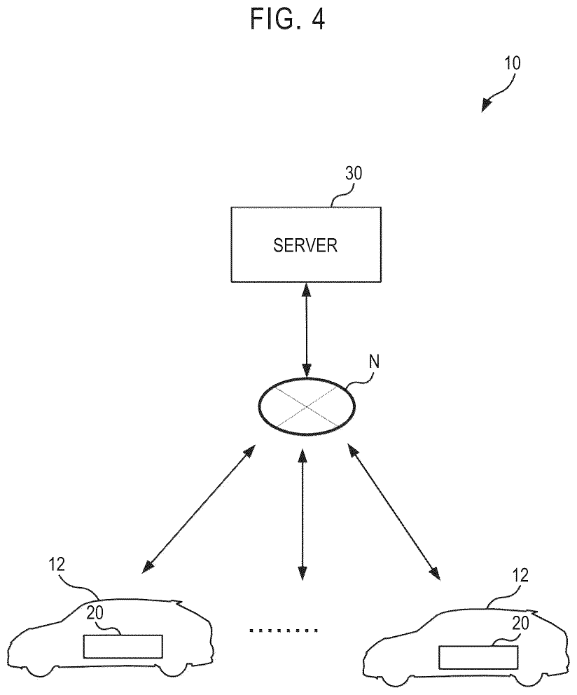

A state estimation system according to an embodiment of the present disclosure will be described below. As illustrated in FIG. 4, the state estimation system 10 according to the embodiment of the present disclosure includes a plurality of vehicles 12 and a server 30 which is a state estimation device. An onboard device 20 is mounted in each of the vehicles 12. The vehicles 12 (the onboard devices 20) and the server 30 are connected to each other via a network N.

Vehicle

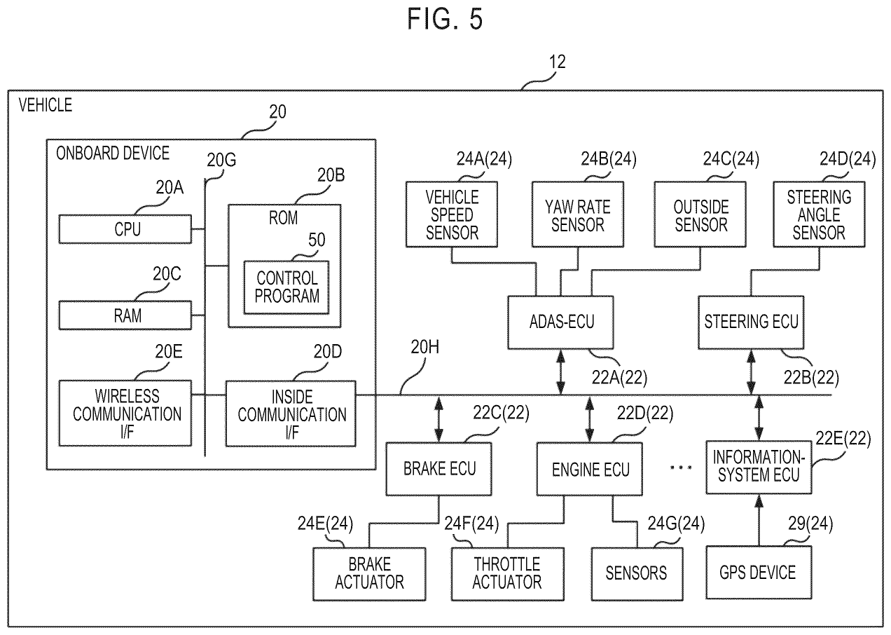

As illustrated in FIG. 5, each vehicle 12 according to this embodiment includes an onboard device 20, a plurality of electronic control units (ECUs) 22, and a plurality of onboard instruments 24.

The onboard device 20 includes a central processing unit (CPU) 20A, a read only memory (ROM) 20B, a random access memory (RAM) 20C, an inside communication interface (I/F) 20D, and a wireless communication I/F 20E. The CPU the ROM 20B, the RAM 20C, the inside communication I/F 20D, and the wireless communication I/F 20E are communicatively connected to each other via an internal bus 20G.

The CPU 20A is a central processing unit and executes various programs or controls the constituents. That is, the CPU 20A reads a program from the ROM 20B and executes the program using the RAM 20C as a work area.

The ROM 20B stores various programs and various types of data. A control program for collecting vehicle information associated with a state and control of the vehicle 12 from the ECU 22 and controlling functions of the vehicle 12 is stored in the ROM 20B according to this embodiment. History information which is backup data of the vehicle information is stored in the ROM 20B. The RAM 20C serves as a work area and temporarily stores programs or data.

The inside communication I/F 20D is an interface for connection to the ECUs 22. The interface employs a communication standard based on a CAN protocol. The inside communication I/F 20D is connected to an external bus 20H.

The wireless communication I/F 20E is a wireless communication module for communicating with the server 30. The wireless communication module employs, for example, a communication standard such as 5G, LTE, or Wi-Fi (registered trademark). The wireless communication I/F 20E is connected to the network N.

The ECU 22 includes at least an advanced driver assistance system (ADAS)-ECU 22A, a steering ECU 22B, a brake ECU 22C, and an engine ECU 22D. The ECUs 22 detect a value (a maximum value) of variation in rotation speed associated with the vehicle 12 using the functions of the ECUs, correlate the detected value with position information detected by a GPS device 29 or the like, and transmits the correlated information from the wireless communication I/F 20E to the server 30. The position information is divided into areas by the server 30.

The ADAS-ECU 22A intensively controls an advanced driver assistance system. A vehicle speed sensor 24A, a yaw rate sensor 24B, and an outside sensor 24C which constitute the onboard instrument 24 are connected to the ADAS-ECU 22A. The outside sensor 24C is a sensor group that is used to detect a surrounding environment of the vehicle 12. The outside sensor 24C includes, for example, a camera that images the surroundings of the vehicle 12, a millimeter wave radar that transmits search waves and receives reflected waves, and a laser imaging detection and ranging (LIDAR) device that scans a space in front of the vehicle 12.

The steering ECU 22B controls power steering. A steering angle sensor 24D constituting the onboard instrument 24 is connected to the steering ECU 22B. The steering angle sensor 24D is a sensor that detects a steering angle of a steering wheel.

The brake ECU 22C controls a brake system of the vehicle 12. A brake actuator 24E constituting the onboard instrument 24 is connected to the brake ECU 22C.

The engine ECU 22D controls an engine of the vehicle 12. A throttle actuator 24F and sensors 24G constituting the onboard instrument 24 are connected to the engine ECU 22D. The sensors 24G include an oil temperature sensor that measures an oil temperature of an engine oil, a hydraulic sensor that measures a hydraulic pressure of the engine oil, and a rotation sensor that detects a rotation speed of the engine.

An information-system ECU 22E controls a car navigation system, an audio system, and the like. The information-system ECU 22E has, for example, a function of displaying road surface damage output from the server 30 on a map of a GUI or the like. A GPS device 29 constituting the onboard instrument 24 is connected to the information-system ECU 22E. The GPS device 29 is a device that measures a current position of the vehicle 12. The GPS device 29 includes an antenna (not illustrated) that receives signals from GPS satellites. The GPS device 29 may be directly connected to the onboard device 20.

Server

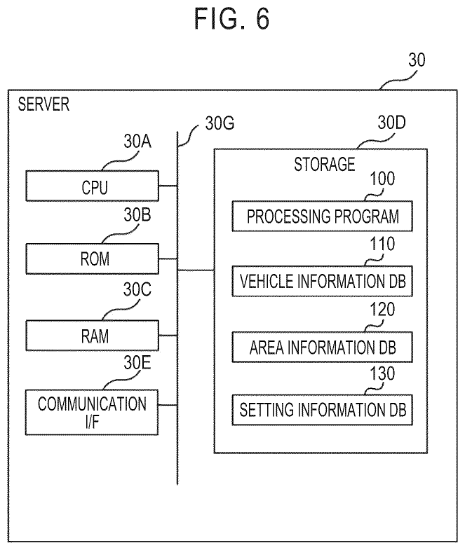

As illustrated in FIG. 6, the server 30 includes a CPU 30A, a ROM 30B, a RAM 30C, a storage 30D, and a communication I/F 30E. The CPU 30A, the ROM 30B, the RAM 30C, the storage 30D, and the communication I/F 30E are communicatively connected to each other via an internal bus 30G. The functions of the CPU 30A, the ROM 30B, the RAM 30C, and the communication I/F 30E are the same as those of the CPU 20A, the ROM 20B, the RAM 20C, and the wireless communication I/F 20E of the onboard device 20. The communication I/F 30E may perform communication in a wireless manner.

The storage 30D serving as a memory is constituted by a hard disk drive (HDD) or a solid state drive (SSD) and stores various programs and various types of data. A processing program 100, a vehicle information database (DB) 110, an area information DB 120, and a setting information DB 130 are stored in the storage 30D according to this embodiment. The ROM 30B may store the processing program 100, the vehicle information DB 110, the area information DB 120, and the setting information DB 130.

The processing program 100 which is a state estimation program is a program for controlling the server 30. When the processing program 100 is executed, the server 30 performs a process of estimating road surface damage.

Vehicle information acquired from the vehicle 12 and position information at the time of acquisition are stored in the vehicle information DB 110. The vehicle information includes information associated with a driving operation and traveling such as a value of variation in rotation speed for each wheel, a vehicle speed, an acceleration, a yaw rate, a steering angle, an accelerator operation amount, a brake pedal depression force, or a stroke. A maximum value of variation in rotation speed for each wheel is stored as information on vehicle behavior in the vehicle information DB 110. The maximum value of variation in rotation speed is acquired from the value of variation in rotation speed for each wheel in the vehicle information. The maximum value of variation in rotation speed is acquired for each of the front-left wheel, the front-right wheel, the rear-left wheel, and the rear-right wheel. The position information of the vehicle 12 is a position of the vehicle 12 acquired from the GPS device 29.

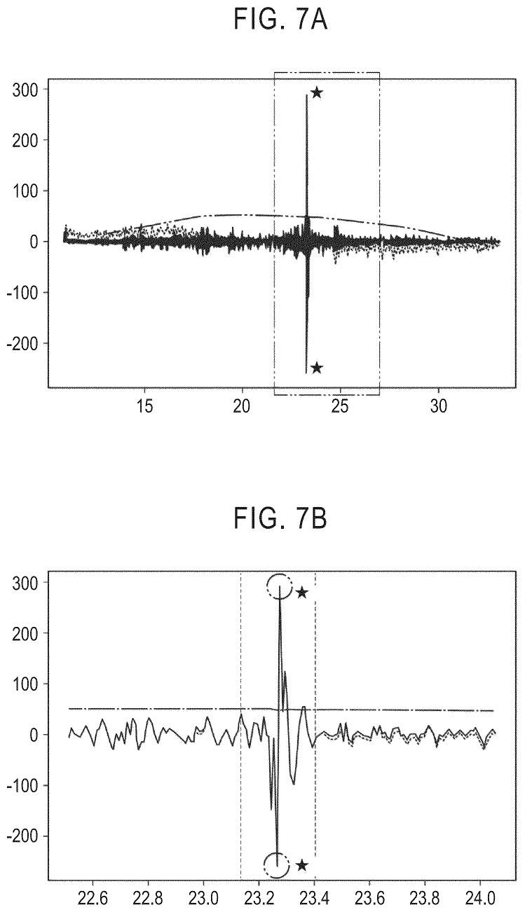

An example of a graph illustrating variation in rotation speed is illustrated in FIG. 7A. The vertical axis represents the variation in rotation speed [km/hs] and the horizontal axis represents the time [s]. An enlargement of a peak of variation in FIG. 7A is a graph illustrated in FIG. 7B. In the graph, a change indicated by a two-dot chain line denotes a vehicle speed. In a behavior acquiring unit 200 which will be described later, an absolute value of the value of a MAX or MIN peak is acquired as the maximum value of variation in rotation speed.

A position on a map of a traveling road on which the vehicle 12 travels and map data for acquiring an area are stored in the area information DB 120. The area is, for example, a section of which a predetermined range on a road is defined as a unit of detection of road surface damage. The behavior acquiring unit 200 which will be described later collects vehicle information for the area and an estimation unit 202 estimates road surface damage for the area. The area may be defined as a plurality of areas in multiple stages. The area which is the section is an example of a predetermined area in the claims. When an area is not used, a maximum value of variation in rotation speed at a near positions based on the position information may be acquired and road surface damage may be estimated.

A first threshold value and a second threshold value are stored in the setting information DB 130. The first threshold value is a threshold value for the maximum value of variation in rotation speed associated with the front wheels. The second threshold value is a threshold value for the maximum value of variation in rotation speed associated with the rear wheels. The first threshold value and the second threshold value are set to different values depending on information on a load of the vehicle 12 for each type of vehicle. Setting of the first threshold value and the second threshold value will be described later.

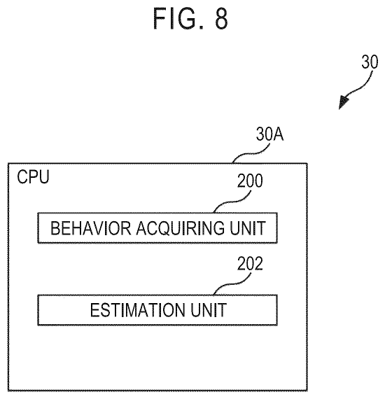

As illustrated in FIG. 8, the CPU 30A of the server 30 according to this embodiment serves as a behavior acquiring unit 200 and an estimation unit 202 by executing the processing program 100.

The behavior acquiring unit 200 acquires the maximum value of variation in rotation speed for each wheel from the vehicle information of the vehicles 12 for each area and stores the acquired maximum values in the vehicle information DB 110.

The estimation unit 202 determines whether the maximum value of variation in rotation speed for each wheel which is information on vehicle behavior is greater than the first threshold value for the front-left wheel and the front-right wheel of the vehicle for each of the vehicles 12 for each area. The estimation unit 202 determines whether the maximum value is greater than the second threshold value for the rear-left wheel and the rear-right wheel of the vehicle for each of the vehicles 12 for each area. When a frequency in which the maximum value for the front-left wheel is greater than the first threshold value and the maximum value for the rear-left wheel is greater than the second threshold value satisfies a predetermined condition for each area or when a frequency in which the maximum value for the front-right wheel is greater than the first threshold value and the maximum value for the rear-right wheel is greater than the second threshold value satisfies a predetermined condition, the estimation unit 202 estimates that road surface damage is present on a road surface in the corresponding area. The predetermined condition can be set to a condition that the frequency in which the maximum value for each wheel is greater than the threshold value is equal to or greater than a predetermined number, a condition that a ratio of the number of vehicles 12 to the whole number is equal to or greater than a predetermined number, or the like.

An example in which it is estimated that road surface damage is present when the predetermined condition is satisfied using data of a plurality of vehicles 12 for each area is described, but the present disclosure is not limited thereto. For example, the estimation unit 202 may perform the determination using the maximum value of variation in rotation speed for each wheel acquired from the vehicle 12 for each vehicle 12 and estimate road surface damage individually for traveling areas or positions for each vehicle 12.

Routine of Control

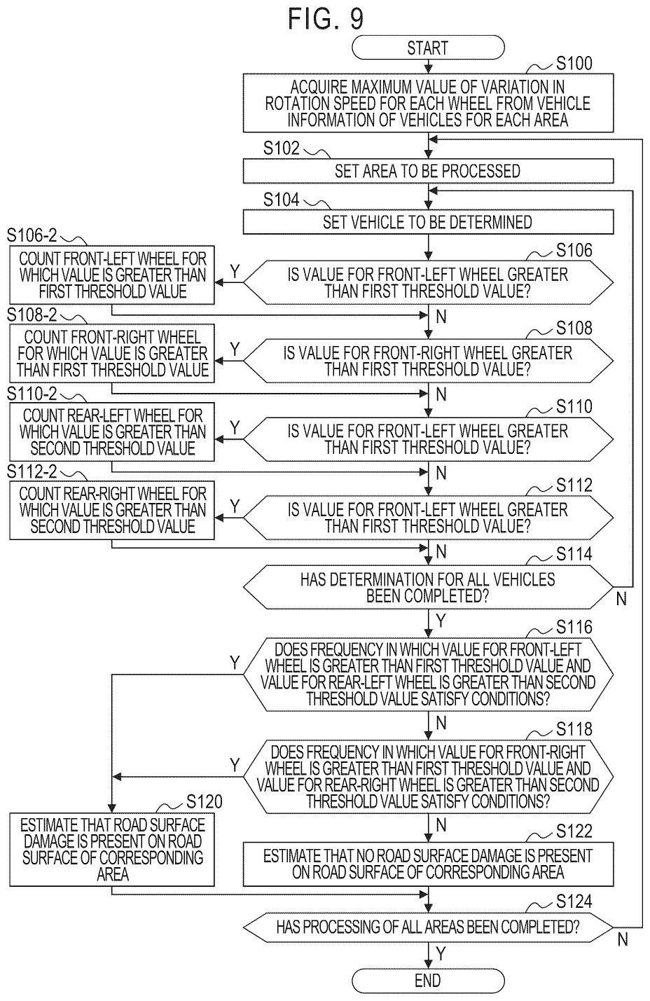

A routine of a state estimation method which is performed by the server 30 according to this embodiment will be described below with reference to the flowchart illustrated in FIG. 9. FIG. 9 is a flowchart illustrating a routine of a state estimation process which is performed by the server 30 according to this embodiment. The routine performed by the server 30 is performed by causing the CPU 30A to serve as the constituents of the server 30.

In Step S100, the CPU 30A acquires the maximum value of variation in rotation speed for each wheel from the vehicle information of each vehicle 12 for each area and stores the acquired maximum values in the vehicle information DB 110.

In Step S102, the CPU 30A sets an area to be processed.

In Step S104, the CPU 30A sets a vehicle 12 which is a determination target.

In Step S106, the CPU 30A determines whether the maximum value for the front-left wheel of the vehicle 12 which is a determination target is greater than the first threshold value. When it is determined that the first threshold value is exceeded, the routine proceeds to Step S106-2 and the front-left wheel for which the first threshold value is exceeded is counted. When it is determined that the first threshold value is not exceeded, the routine proceeds to Step S108.

In Step S108, the CPU 30A determines whether the maximum value for the front-right wheel of the vehicle 12 which is a determination target is greater than the first threshold value. When it is determined that the first threshold value is exceeded, the routine proceeds to Step S108-2 and the front-right wheel for which the first threshold value is exceeded is counted. When it is determined that the first threshold value is not exceeded, the routine proceeds to Step S110.

In Step S110, the CPU 30A determines whether the maximum value for the rear-left wheel of the vehicle 12 which is a determination target is greater than the second threshold value. When it is determined that the second threshold value is exceeded, the routine proceeds to Step S110-2 and the rear-left wheel for which the second threshold value is exceeded is counted. When it is determined that the second threshold value is not exceeded, the routine proceeds to Step S112.

In Step S112, the CPU 30A determines whether the maximum value for the rear-right wheel of the vehicle 12 which is a determination target is greater than the second threshold value. When it is determined that the second threshold value is exceeded, the routine proceeds to Step S112-2 and the rear-right wheel for which the second threshold value is exceeded is counted. When it is determined that the second threshold value is not exceeded, the routine proceeds to Step S114.

In Step S114, the CPU 30A determines whether determination for all the vehicles 12 which are determination targets has been completed. The routine proceeds to Step S116 when the determination for all the vehicles has been completed, and the routine proceeds to Step S104 and the routine is repeated for a next vehicle 12 when the determination for all the vehicles has not been completed.

In Step S116, the CPU 30A determines whether the frequency in which the front-left wheel is greater than the first threshold value and the rear-left wheel is greater than the second threshold value satisfies the condition for an area to be processed. The routine proceeds to Step S120 when the condition is satisfied. The routine proceeds to Step S118 when the condition is not satisfied.

In Step S118, the CPU 30A determines whether the frequency in which the front-right wheel is greater than the first threshold value and the rear-left wheel is greater than the second threshold value satisfies the condition for an area to be processed. The routine proceeds to Step S120 when the condition is satisfied. The routine proceeds to Step S122 when the condition is not satisfied.

In Step S120, the CPU 30A estimates that road surface damage is present on a road surface in the corresponding area and stores the estimation result in the area information DB 120 or the like. The estimation result of road surface damage in the area may be transmitted to the corresponding vehicle 12.

In Step S122, the CPU 30A estimates that road surface damage is not present on the road surface of the corresponding area and stores the estimation result in the area information DB 120 or the like.

In Step S124, the CPU 30A determines whether processing for all the areas to be processed has been completed. The routine ends when the processing for all the areas has been completed. When the processing for all the areas has not been completed, the routine returns to Step S102 and the routine is repeated for a next vehicle 12.

Setting Example of First Threshold Value and Second Threshold Value

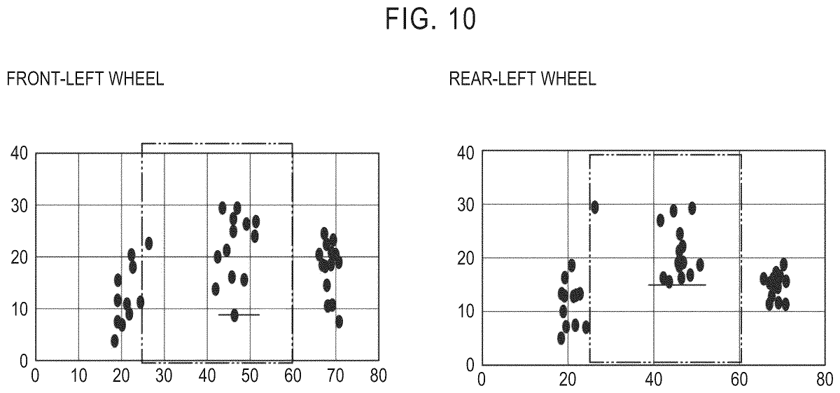

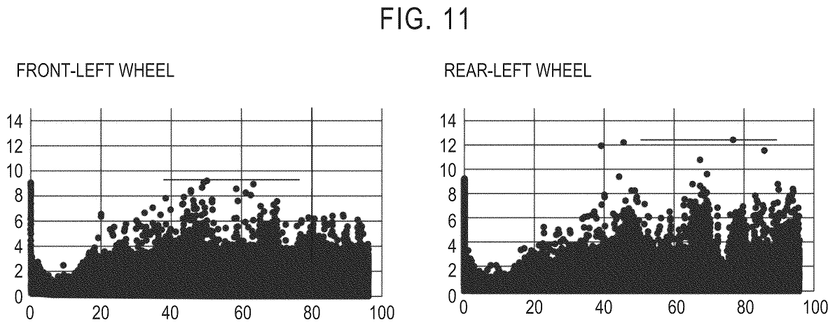

A setting example of the first threshold value and the second threshold value will be described below. FIG. 10 illustrates graphs in which maximum values of variation in rotation speed on a traveling road with road surface damage are collected and plotted. FIG. 11 illustrates graphs in which maximum values of variation in rotation speed on a traveling road with no road surface damage are collected and plotted. In any graph, the vertical axis represents the maximum value of variation in rotation speed and the horizontal axis represents the vehicle speed (km/h). Paying attention to data in FIGS. 10 and 11, for the front wheels, a lower limit of the maximum value on the road surface with no damage may be higher than a lower limit of the maximum value on the road surface with a damage. Accordingly, in this case, the first threshold value is set using the lower limit of the maximum value on the road surface with no damage. For the rear wheels, since the lower limit of the maximum value on the road surface with damage is higher than the lower limit of the maximum value on the road surface with no damage, the second threshold value for the rear wheels is set using the lower limit of the maximum value on the road surface with a damage. A value with a converted unit may be used as the maximum value of variation in rotation speed.

In this way, the first threshold value and the second threshold value can be set through statistical comparison of the collected data. In the aforementioned example, the first threshold value is set to be less than the second threshold value. This is because a load of the vehicle differs between when the vehicle is of a type with a vehicle body structure of front-wheel drive and when the vehicle is of a type with a vehicle body structure of rear-wheel drive. A load of a vehicle changes due to a payload of the vehicle. When the vehicle is of a type with a vehicle body structure of front-wheel drive, the maximum value of variation in rotation speed of the front wheels is observed to be less. Accordingly, when the vehicle is of a type with a vehicle body structure of front-wheel drive, the first threshold value is set to be less than the second threshold value. In this way, the threshold values are set to be different based on a vehicle body structure which varies according to a drive system. The vehicle body structure and the payload of the vehicle are examples of information on a load of a vehicle according to the present disclosure.

The first threshold value and the second threshold value may be set using a trained model. When a trained model is used, model training can be performed using machine learning through a process of training the processing program 100. The processing program 100 learns a model of outputting the first threshold value and a model of outputting the second threshold value based on training data for each type of vehicle. The training data includes information on a load of a vehicle for the type of the vehicle, training information on vehicle behavior (the maximum value of variation in rotation speed for each wheel with position information) collected for the type of the vehicle, and a correct answer label of road surface damage with position information. The models may be additionally trained by feature clusters divided in each region or area. Accordingly, the first threshold value and the second threshold value are set to different values using the trained models trained through machine learning.

As described above, the server 30 which is the state estimation device according to this embodiment determines whether the maximum value for the front-left wheel and the front-right wheel in the information on vehicle behavior is greater than the first threshold value for each of the vehicles 12 for each area and estimates that road surface damage is present on the road surface for the corresponding area when the condition is satisfied. In this way, the server 30 enables detection accuracy of road surface damage to be secured without being affected by external factors or accidental vibration.

In comparison with the technique of detecting road surface damage based on a time-series change, with the technique according to this embodiment, since road surface damage is directly estimated based on the magnitude of variation in rotation speed, it is possible to comprehensively detect an original road surface damage not varying in a time series. A damaged state of a road needs to be comprehensively ascertained in road maintenance work. With the technique according to this embodiment, since road surface damage can be comprehensively detected in an area of a road, this is useful in view of road maintenance.

In the aforementioned embodiment, an example in which variation in rotation speed of tires is used as the information on vehicle behavior has been described, this applicable configuration can be diversely applied in view of the concept of observing great variation in both the front and rear sides of a vehicle. In a modified example, for example, vibration of a shock absorber or a coil spring supporting four wheels of tires can be used as information on vehicle behavior. Vibration of acceleration sensors disposed in various parts of the vehicle can be used as the information on vehicle behavior. Variation in sound volume or frequency characteristics generated on the front and rear sides of the vehicle can be used as the information on vehicle behavior. Vibration of various parts of a vehicle can be used as the information on vehicle behavior. The same can be applied to a battery electric vehicle (BEV) and a fuel cell electric vehicle (FCEV), and it is possible to reduce noise based on a protrusion and a recess of a road surface such as vibration of the engine when a system for such vehicles is constructed and to improve detection accuracy of road surface damage.

With the technique according to this embodiment, the whole target region can be detected by collecting and handling vehicle information as big data from a plurality of vehicles in a wide range. In this case, the processing cost increases with an increase in data volume, but, for example, when the same process is performed on a region a plurality of times, a spot (area) in which road surface damage can occur is selected from the previous result and processing is performed on only the selected spot in a method of reducing a data processing load. For example, processing is performed on only a narrowed road in which the road surface damage is detected on a road with a large traffic volume or in the vicinity thereof.

In the aforementioned embodiment, various processes which are performed by causing the CPU 20A and the CPU 30A to read and execute software (a program) may be performed by various processors other than the CPUs. A programmable logic device (PLD) of which a manufactured circuit configuration can be changed such as a field-programmable gate array (FPGA), a dedicated electrical circuit which is a processor with a circuit configuration designed dedicatedly for performing specific processes such as an application-specific integrated circuit (ASIC), and the like can be exemplified as the processor in this case. The aforementioned processes may be performed by one of such various processors or may be performed by a combination of the same or different two or more processors (for example, a combination of a plurality of FPGAs or a combination of a CPU and an FPGA). A hardware structure of various processors is more specifically an electrical circuit in which circuit elements such as semiconductor elements are combined.

In the aforementioned embodiment, various programs are stored (installed) in a non-transitory computer-readable recording medium in advance. For example, the programs in the onboard device 20 are stored in the ROM 20B in advance, and the processing program 100 in the server 30 is stored in the storage 30D in advance. However, the present disclosure is not limited thereto, and various programs may be provided in a state in which they are recorded on a non-transitory recording medium such as a compact disc read only memory (CD-ROM), a digital versatile disc read only memory (DVD-ROM), and a universal serial bus (USB) memory. The programs may be downloaded from an external device via a network.

The routine of processes described above in the embodiment is an example, and the routine may be changed by deleting an unnecessary step or adding a new step without departing from the gist.

What is claimed is:

1. A state estimation device comprising:
a behavior acquiring unit configured to acquire information on vehicle behavior of front wheels and rear wheels of a vehicle; and
an estimation unit configured to estimate that road surface damage is present when a value associated with the front wheels in the information on vehicle behavior is greater than a first threshold value and a value associated with the rear wheels is greater than a second threshold value.

2. The state estimation device according to claim 1, wherein the estimation unit determines whether the value is greater than the first threshold value for each of the front-right wheel and the front-left wheel in the information on vehicle behavior and determines whether the value is greater than the second threshold value for each of the rear-right wheel and the rear-left wheel in the information on vehicle behavior, and
wherein the estimation unit estimates that the road surface damage is present when the value associated with the front-left wheel is greater than the first threshold value and the value associated with the rear-left wheel is greater than the second threshold value or when the value associated with the front-right wheel is greater than the first threshold value and the value associated with the rear-right wheel is greater than the second threshold value.

3. The state estimation device according to claim 1, wherein variation in wheel rotation speed of each tire of the vehicle is used as the information on vehicle behavior.

4. The state estimation device according to claim 1, wherein the behavior acquiring unit acquires the information on vehicle behavior from a plurality of vehicles,
wherein the estimation unit determines whether the value of the front wheels of a corresponding vehicle is greater than the first threshold value and determines whether the value associated with the rear wheels of the vehicle is greater than the second threshold for each of the plurality of vehicles, and
wherein the estimation unit estimates that the road surface damage is present when the number of vehicles for which the value is greater than the first threshold value and the number of vehicles for which the value is greater than the second threshold value satisfy a predetermined condition.

5. The state estimation device according to claim 4, wherein the behavior acquiring unit acquires the information on vehicle behavior from each of the plurality of vehicles for each predetermined area, and
wherein the estimation unit performs the determination using the first threshold value and the second threshold value for each predetermined area and estimates that the road surface damage is present when the predetermined condition is satisfied.

6. The state estimation device according to claim 1, wherein the first threshold value and the second threshold value are set to different values according to information on a load of the vehicle for each type of the vehicle.

7. The state estimation device according to claim 6, wherein the first threshold value is set to be smaller than the second threshold value when the vehicle is of a type with a vehicle body structure of front-wheel drive.

8. The state estimation device according to claim 6, wherein the first threshold value and the second threshold value are set to different values using a trained model which has been trained by machine learning based on the information on a load of each vehicle, the information on vehicle behavior for training collected for each vehicle type, and a correct answer label of road surface damage for each vehicle type.

9. A state estimation method that is performed by a processor of a computer, the state estimation method comprising:
acquiring information on vehicle behavior of front wheels and rear wheels of a vehicle; and
estimating that road surface damage is present when a value associated with the front wheels in the information on vehicle behavior is greater than a first threshold value and a value associated with the rear wheels is greater than a second threshold value.

10. A non-transitory storage medium storing a state estimation program causing a processor of a computer to perform:
acquiring information on vehicle behavior of front wheels and rear wheels of a vehicle; and
estimating that road surface damage is present when a value associated with the front wheels in the information on vehicle behavior is greater than a first threshold value and a value associated with the rear wheels is greater than a second threshold value.
